(19) United States
(12) Patent Application Publication
(10) Pub. No.: US 2009/0078092 A1
(43) Pub. Date: Mar. 26, 2009

(54) Wrench with curved handle

(76) Inventor: CHIH-CHING HSIEH, Fengyuan City (TW)

Correspondence Address: PHILLIP LIU, 6980, WHITEOAK DR., RICHMOND, BC, V7EAZ9, CA

(21) Appl. No.: 11/902,542

(22) Filed: Sep. 24, 2007

(51) Int. Cl. B25B 13/06

(52) U.S. Cl. 81/121.1

(57) ABSTRACT

A wrench includes a curved handle including a bent portion located between two ends of the curved handle. Two sockets are connected to two ends of the curved handle and one of the socket includes a passage defined axially therethrough and the passage communicates with an opening defined through the bent portion so as to reduce concentration of stress at the bent portion.

### FIELD OF THE INVENTION

The present invention relates to a wrench with a curved handle and two sockets are connected to two ends of the handle, a passage defined through one of the socket and the handle.

### BACKGROUND OF THE INVENTION

A conventional wrench with a curved handle is shown in FIG. 7 and generally includes a curved handle 60 with two sockets 62 on two ends of the curved handle 60. The curved handle 60 includes a bent portion 61 which includes a cut-off 611 so as to reduce concentration of stress at the bent portion 61 when using the wrench. It is noted that the cut-off 611 removes a significant material from the curved handle 60 and that reduces the structural strength of the curved handle 60. The bent portion 61 could be deformed if a large torque is applied to it.

The present invention intends to provide a wrench which includes a curved handle with two sockets connected on two ends thereof and a passage is defined axially through one of the two sockets and the handle. The passage allows a long threaded rod to extend and also reduces the concentration of stress of the bent portion of the curved handle.

### SUMMARY OF THE INVENTION

The present invention relates to a wrench which comprises a curved handle with a bent portion located between two ends of the curved handle and one of the two ends of the curved handle is connected with a first socket. A passage is defined axially through the first socket.

The primary object of the present invention is to provide a wrench with a curved handle and two sockets are connected to two ends of the curved handle, one of the two sockets has a passage defined therethrough which forms an opening at the bent portion of the curved handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention, wherein the handle is not yet curved;

FIG. 2 is a perspective view to show the wrench of the present invention, wherein the handle is curved;

FIG. 3 is a partial cross sectional view to show the wrench of the present invention with the first and second sockets;

FIG. 4 is a partial cross sectional view to show the passage is defined through the first socket and forms an opening at the bent portion of the curved handle of the wrench of the present invention;

FIG. 5 shows the first socket is used to unscrew a nut on a long threaded rod;

FIG. 6 is a partial cross sectional view to show the long threaded rod extends through the first socket and into the passage, and

FIG. 7 is a perspective view to show a conventional wrench with a curved handle.

### DETAILED DESCRIPTION OF THE PREFERRED EMBODIMENT

Referring to FIG. 4, the wrench 10 of the present invention comprises a curved handle 20 including a bent portion 23 located between two ends of the curved handle 20, two ends of the curved handle 20 are connected with a first socket 30 and a second socket 40 respectively. The curved handle 20 includes a first section 21 and a second section 22, the bent portion 23 is connected between the first and second sections 21, 22. The first socket 30 is connected to the first section 21 and the second socket 40 is connected to the second section 22. A passage 24 is defined axially through the first socket 30 and forms an opening 231 defined through the bent portion 23 of the curved handle 20. The passage 24 is also defined axially through the first section 21. The axis of the first passage 24 extends through a center of the opening 231. The opening 231 is designed to reduce concentration of stress at the bent portion 23. An enlarged and polygonal inner space 31 is defined in the first socket 30. It is noted that the first and second sockets 30, 40 preferably include two different sizes to meet different needs.

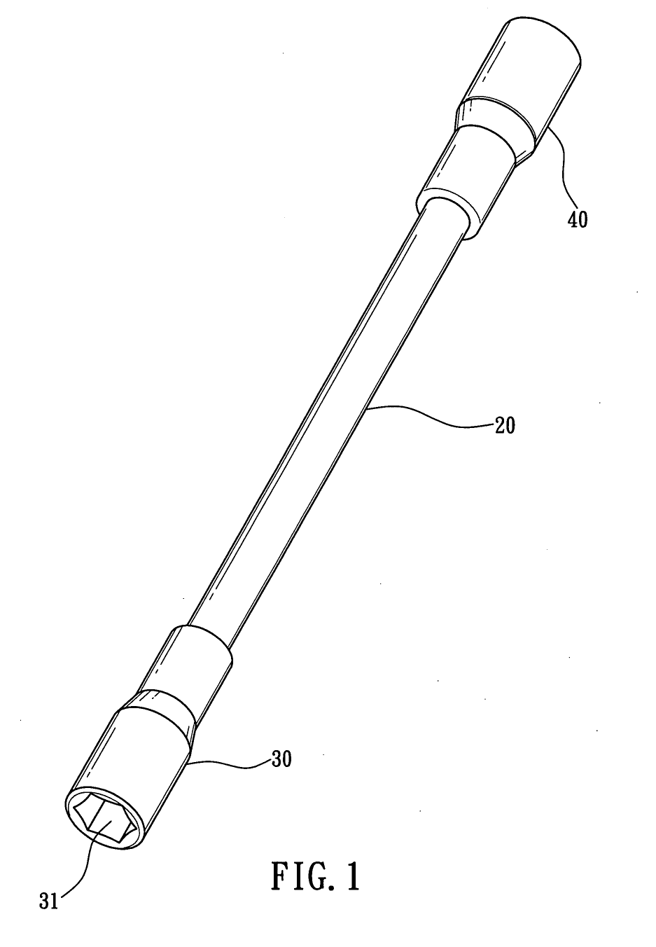

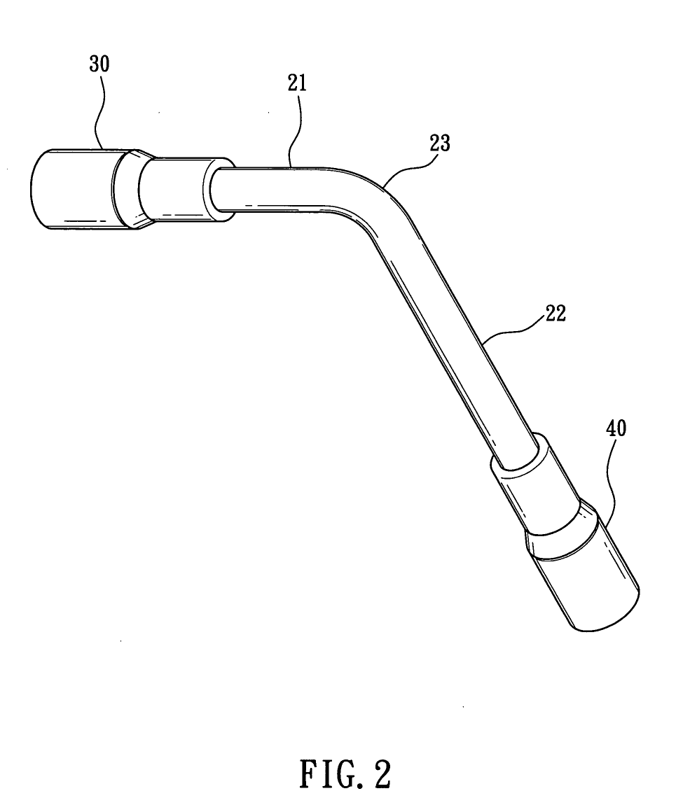

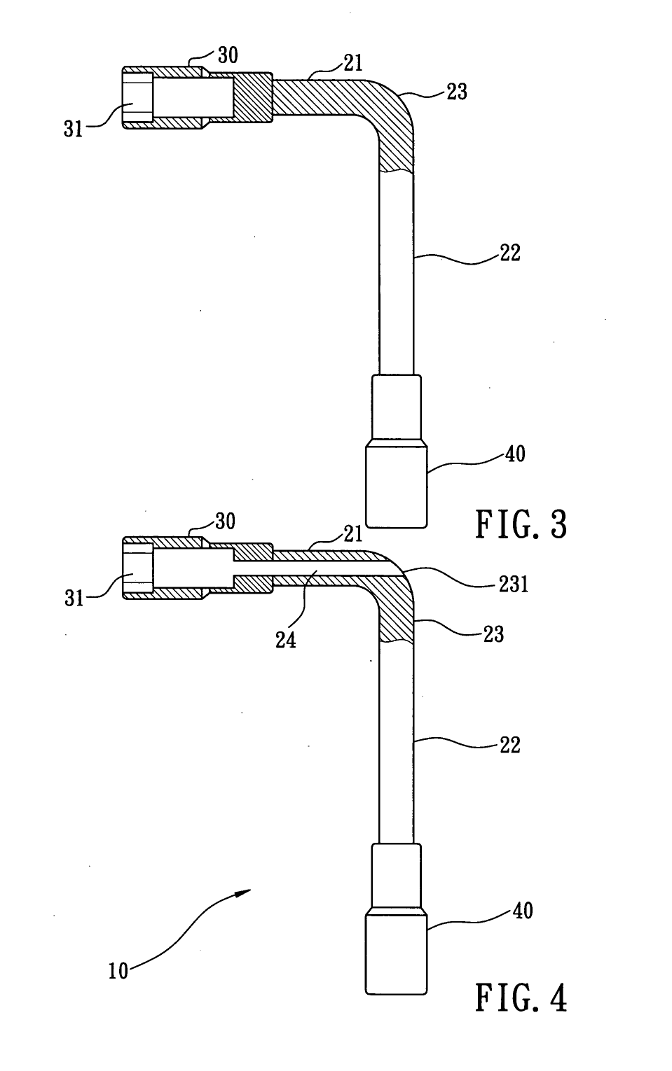

As shown in FIGS. 1 to 4, which show the shapes in different steps during manufacturing, wherein the handle of the wrench 10 is a straight handle in the first step and the handle is then bent to form the first section 21 and the second section 22. The two respective axes of the first and second sections 21, 22 are perpendicular to each other.

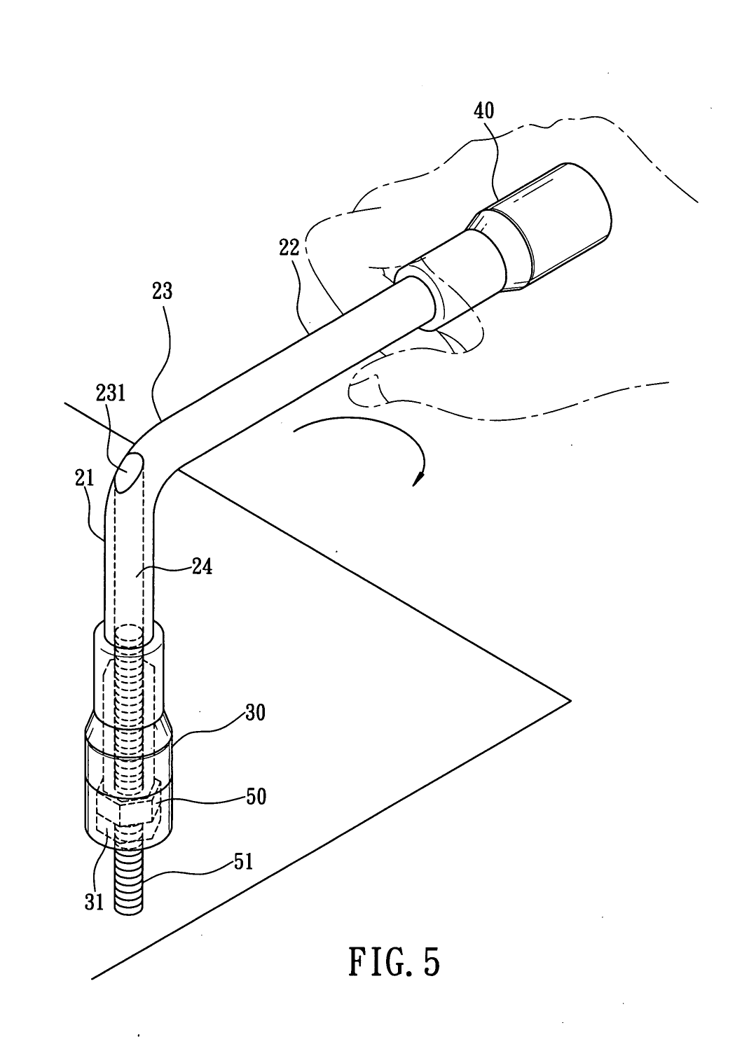

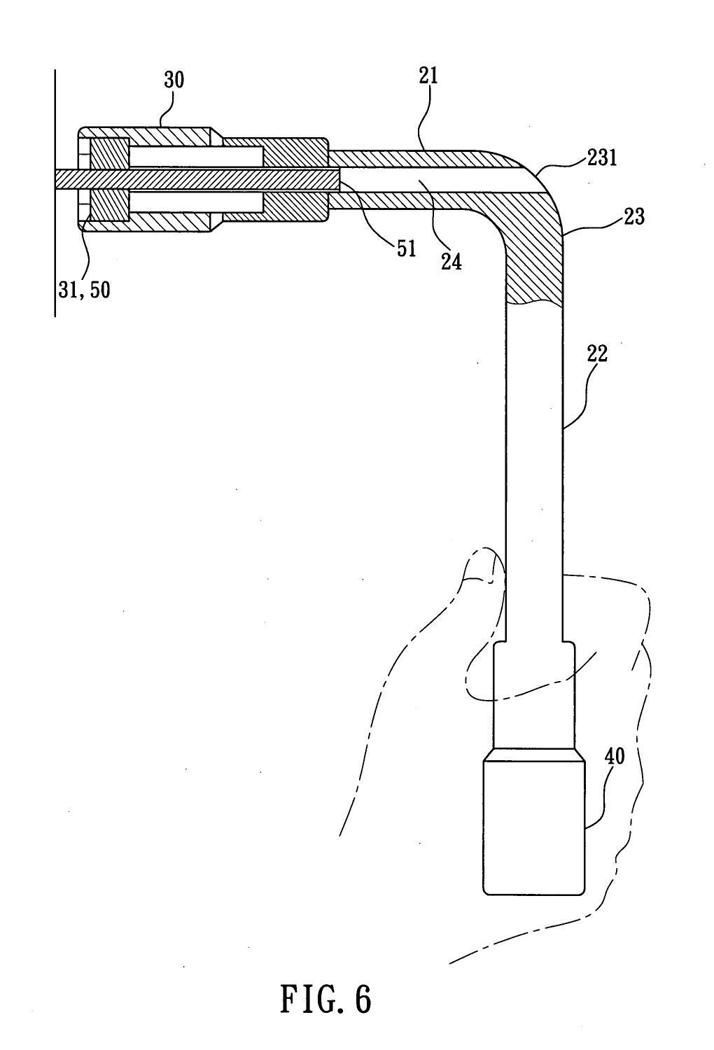

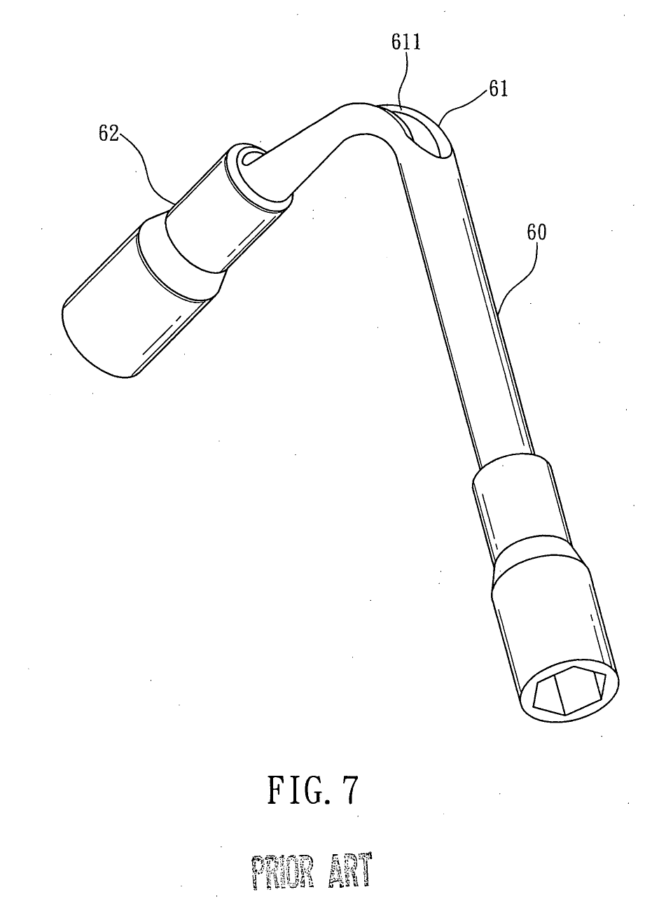

As shown in FIGS. 5 and 6, when using the first socket 30 to unscrew a nut 50 on the long threaded rod 51, the nut 50 is engaged with the enlarged and polygonal inner space 31 of the first socket 30 and the long threaded rod 51 extends through the first socket 30 and into the passage 24 in the first section 21. The user holds the second section 22 and rotates to unscrew the nut 50 without worry about the length of the threaded rod 51.

The opening 231 reduces the concentration of stress at the bent portion 23 while the structural strength of the bent portion 23 is maintained.

While we have shown and described the embodiment in accordance with the present invention, it should be clear to those skilled in the art that further embodiments may be made without departing from the scope of the present invention.

What is claimed is:

1. A wrench comprising:
a curved handle including a bent portion located between two ends of the curved handle, one of the two ends of the curved handle connected with a first socket, and
a passage defined axially through the first socket.

2. The wrench as claimed in claim 1, wherein the curved handle includes a first section and a second section, the bent portion is connected between the first and second sections, the first socket is connected to the first section and the passage is defined axially through the first section.

3. The wrench as claimed in claim 1, wherein an opening is defined through the bent portion of the curved handle.

4. The wrench as claimed in claim 2, wherein an opening is defined through the bent portion of the curved handle and communicates with the passage.

5. The wrench as claimed in claim 1, a second socket is connected to the second section of the curved handle.

6. The wrench as claimed in claim 4, wherein the opening reduces concentration of stress at the bent portion.

7. The wrench as claimed in claim 1, wherein an enlarged and polygonal inner space is defined in the first socket.
